(19) United States
(12) Patent Application Publication
(10) Pub. No.: US 2013/0057425 A1
(43) Pub. Date: Mar. 7, 2013

(54) PULSED LEVEL GAUGE SYSTEM WITH CONTROLLABLE DELAY PATH THROUGH SELECTED NUMBER OF DELAY CELLS

(71) Applicants: Fabian Wenger, Goteborg (SE); Samuel Bergqvist, Goteborg (SE); Valter Nilsson, Hovas (SE)

(72) Inventors: Fabian Wenger, Goteborg (SE); Samuel Bergqvist, Goteborg (SE); Valter Nilsson, Hovas (SE)

(21) Appl. No.: 13/225,771

(22) Filed: Sep. 6, 2011

(51) Int. Cl. G01S 13/08

(52) U.S. Cl. 342/124

(57) ABSTRACT

A level gauge system comprising transmission signal generating circuitry for generating a transmission signal; a propagation device connected to the transmission signal generating circuitry and arranged to propagate the transmission signal towards a surface of the product inside the tank, and to return a reflected signal resulting from reflection of the transmission signal at the surface of the product contained in the tank. The level gauge system further comprises reference signal providing circuitry configured to provide a reference signal. At least one of the transmission signal generating circuitry and the reference signal providing circuitry comprises delay circuitry. The delay circuitry comprises a plurality of delay cells, and controllable switching circuitry arranged and configured to allow formation of a delay path comprising a subset of the plurality of delay cells connected in series, to thereby allow control of a signal propagation delay of the delay circuitry.

### TECHNICAL FIELD OF THE INVENTION

The present invention relates to a method of determining a filling level of a product contained in a tank using electromagnetic signals, and to a pulsed level gauge system using electromagnetic signals with controllable signal delay.

### TECHNICAL BACKGROUND

Radar level gauge (RLG) systems are in wide use for determining the filling level of a product contained in a tank. Radar level gauging is generally performed either by means of non-contact measurement, whereby electromagnetic signals are radiated towards the product contained in the tank, or by means of contact measurement, often referred to as guided wave radar (GWR), whereby electromagnetic signals are guided towards and into the product by a probe acting as a waveguide. The probe is generally arranged to extend vertically from the top towards the bottom of the tank. The probe may also be arranged in a measurement tube, a so-called chamber, that is connected to the outer wall of the tank and is in fluid connection with the inside of the tank.

The transmitted electromagnetic signals are reflected at the surface of the product, and the reflected signals are received by a receiver or transceiver comprised in the radar level gauge system. Based on the transmitted and reflected signals, the distance to the surface of the product can be determined.

More particularly, the distance to the surface of the product is generally determined based on the time between transmission of an electromagnetic signal and reception of the reflection thereof in the interface between the atmosphere in the tank and the product contained therein. In order to determine the actual filling level of the product, the distance from a reference position to the surface is determined based on the above-mentioned time (the so-called time-of-flight) and the propagation velocity of the electromagnetic signals.

Most radar level gauge systems on the market today are either so-called pulsed radar level gauge systems that determine the distance to the surface of the product contained in the tank based on the difference in time between transmission of a pulse and reception of its reflection at the surface of the product, or systems that determine the distance to the surface based on the phase difference between a transmitted frequency-modulated signal and its reflection at the surface. The latter type of systems are generally referred to as being of the FMCW (Frequency Modulated Continuous Wave) type.

For pulsed radar level gauge systems, time expansion techniques are generally used to resolve the time-of-flight.

Such pulsed radar level gauge systems typically have a first oscillator for generating a transmission signal formed by pulses for transmission towards the surface of the product contained in the tank with a transmitted pulse repetition frequency fₜ, and a second oscillator for generating a reference signal formed by reference pulses with a reference pulse repetition frequency fᵣ that differs from the transmitted pulse repetition frequency by a given frequency difference Δf. This frequency difference Δf is typically in the range of Hz or tens of Hz.

At the beginning of a measurement sweep, the transmission signal and the reference signal are synchronized to have the same phase. Due to the frequency difference Δf, the phase difference between the transmission signal and the reference signal will gradually increase during the measurement sweep.

During the measurement sweep, the reflection signal formed by the reflection of the transmission signal at the surface of the product contained in the tank is being correlated with the reference signal, so that an output signal is only produced when a reflected pulse and a reference pulse occur at the same time. The time from the start of the measurement sweep to the occurrence of the output signal resulting from the correlation of the reflection signal and the reference signal is a measure of the phase difference between the transmission signal and the reflection signal, which is in turn a time expanded measure of the time-of-flight of the reflected pulses, from which the distance to the surface of the product contained in the tank can be determined.

Since the accuracy of the frequency difference Δf between the transmission signal and the reference signal is important to the performance of the pulsed radar level gauge system, the second oscillator can be controlled by a regulator that monitors the frequency difference Δf and regulates the second oscillator to maintain the predetermined frequency difference Δf.

To provide a stable regulation, the regulator may typically need in the order of hundreds of samples of the frequency difference Δf, which corresponds to a time duration which can be as long as 20-30 seconds due to the low value of the frequency difference Δf that is desired to achieve a sufficient time expansion.

Accordingly, the above-described type of currently available pulsed radar level gauge systems typically need to be powered for a substantial period of time before the actual filling level measurement can start.

### SUMMARY OF THE INVENTION

In view of the above-mentioned and other drawbacks of the prior art, a general object of the present invention is to provide an improved pulsed level gauge system and method, and in particular a pulsed level gauge system and method enabling a more energy efficient filling level determination.

According to a first aspect of the present invention, these and other objects are achieved through a level gauge system, for determination of a filling level of a product contained in a tank using electromagnetic signals, the level gauge system comprising transmission signal generating circuitry for generating a transmission signal in the form of a sequence of transmission pulses; a propagation device connected to the transmission signal generating circuitry and arranged to propagate the transmission signal towards a surface of the product inside the tank, and to return a reflected signal resulting from reflection of the transmission signal at the surface of the product contained in the tank; reference signal providing circuitry configured to provide a reference signal in the form of a sequence of reference pulses, at least one of the transmission signal generating circuitry and the reference signal providing circuitry comprising delay circuitry for providing a time-varying phase difference between the transmission signal and the reference signal; measurement circuitry connected to the propagation device and to the reference signal providing circuitry, the measurement circuitry being configured to provide a measurement signal based on the reference signal and the reflected signal; and processing circuitry connected to the measurement circuitry for determining a filling level based on the measurement signal, wherein the delay circuitry comprises: a plurality of delay cells; and controllable switching circuitry arranged and configured to allow formation of a delay path comprising a subset of the plurality of delay cells connected in series, to thereby allow control of a signal propagation delay of the delay circuitry.

The tank may be any container or vessel capable of containing a product, and may be metallic, or partly or completely non-metallic, open, semi-open, or closed. Furthermore, the filling level of the product contained in the tank may be determined directly by using a signal propagation device propagating the transmission signal towards the product inside the tank, or indirectly by using a propagation device disposed inside a so-called chamber located on the outside of the tank, but being in fluid connection with the inside of the tank in such a way that the level in the chamber corresponds to the level inside the tank. The transmission signal is an electromagnetic signal.

The “propagation device” may be any device capable of propagating electromagnetic signals, including transmission line probes, waveguides and various types of antennas, such as horn antennas, array antennas etc.

It should be noted that any one or several of the means comprised in the processing circuitry may be provided as either of a separate physical component, separate hardware blocks within a single component, or software executed by one or several microprocessors.

The present invention is based on the realization that a controllable timing difference between the transmission pulses and the reference pulses can be achieved by arranging delay cells in series and controlling the number of delay cells through which pulses should be passed to provide either of (or both) the transmission pulses and the reference pulses. Delay cells and controllable switching circuitry for forming a delay path through a selected number of delay cells may be comprised in either the transmission signal generating circuitry or the reference signal providing circuitry or both. For example, the transmission signal generating circuitry may comprise a oscillator circuitry, such as a voltage controlled oscillator, and the reference signal providing circuitry may comprise delay circuitry for providing a reference signal in the form of a delayed version of the transmission signals.

Through the use of delay circuitry comprising a plurality of delay cells, each providing a known propagation delay (which may be the same for all delay cells, or differ between delay cells) for electromagnetic signals passing therethrough, and controllable switching circuitry arranged and configured to allow formation of a delay path through a selected number of the delay cells connected in series, the delay can be controlled to a desired value at any time. This allows for various power saving operation modes of the level gauge system. For example, a ‘quick search’ mode can be used where the delay is varied rapidly by skipping delay cells. Hereby, the surface of the product in the tank can quickly be found, and subsequent measurements may be carried out for a limited range around the distance to the surface. To measure across such a limited range, the switching circuitry is controlled to successively form delay paths through delay cells corresponding to the range around the distance to the surface. To measure across a limited range like this saves time and power as compared to performing “complete” measurements across the entire range of the level gauge system. The thus saved power as compared to a measurement across the entire range of the level gauge system may, for example, be used to instead oversample a selected range or “window” a number of times, whereby the sensitivity can be improved.

The transmission signal generating circuitry and the reference signal providing circuitry may advantageously provide the transmission signal and the reference signal, respectively, based on input from a common pulse generating circuit.

According to various embodiments of the present invention, the delay circuitry may further comprise at least one delay tuning cell exhibiting a propagation delay for pulses passing through the at least one delay tuning cell that varies in dependence of a supply voltage provided to the at least one delay tuning cell; and voltage control circuitry connected to the at least one delay tuning cell for providing a controllable supply voltage to the at least one delay tuning cell, to thereby allow control of the propagation delay of the at least one delay tuning cell.

Hereby, the total propagation delay provided by the delay circuitry can be controlled more accurately, which provides for an improved accuracy in the filling level determination.

The at least one delay tuning cell may be connected in series with the delay path formed by the above-mentioned selected number of delay cell. In this manner, the total propagation delay of the delay circuitry is provided by the sum of the total delay of the delay path and the at least one delay tuning cell.

Alternatively, the delay cells forming the delay path may be comprised in the reference signal providing circuitry and the at least one delay tuning cell may be comprised in the transmission signal generating circuitry, or vice versa.

Moreover, the delay circuitry may comprise a plurality of delay tuning cells connected in series, each delay tuning cell exhibiting a propagation delay for pulses passing through the delay tuning cell that varies in dependence of a supply voltage provided to the delay tuning cell. This provides for tuning of the total propagation delay over an increased range and/or with increased precision, which in turn provides for an improved measurement accuracy.

Furthermore, the voltage control circuitry may be connected to each of the delay tuning cells to allow simultaneous control of the supply voltage provided to each of the delay tuning cells.

In various embodiments of the present invention, at least one of the delay cells may exhibit a propagation delay for pulses passing through the at least one delay cell that varies in dependence of a supply voltage provided to the at least one delay cell, and the delay circuitry may further comprise voltage control circuitry connected to the at least one delay cell for providing a controllable supply voltage to the at least one delay cell.

Since, in these embodiments, one or several of the delay cells exhibit a supply voltage dependent propagation delay, variation of the total propagation delay of the delay circuitry may be achieved by varying the number of delay cells forming the delay path and, for each number of delay cells, varying the supply voltage provided to the delay cell(s) that exhibit(s) a supply voltage dependent propagation delay. In various embodiments, this may be combined with the above-mentioned delay tuning cells.

To provide for characterization and/or adjustment of the delay circuitry, the level gauge system may further comprise a phase detector arranged to provide a signal indicative of a propagation delay through the plurality of delay cells. This signal may be used to achieve a stable and accurate control of the total propagation delay of the delay circuitry.

For example, in embodiments where one or several of the delay cells exhibit(s) a supply voltage dependent propagation delay, the voltage control circuitry used for controlling the supply voltage provided to those delay cells may be connected to the phase detector and configured to provide the controllable supply voltage in dependence of the signal provided by the phase detector.

For formation of the delay path, the switching circuitry may comprise controllable switching elements arranged between adjacent ones of the delay cells. Alternatively, all of the delay cells may be connected in series, and the switching circuitry may comprise controllable switching elements for connecting a selected one of the delay cells to an output of the delay circuitry.

In various embodiments of the present invention, the at least one delay cell may be a logic circuit comprising at least one transistor. In embodiments comprising one or several delay tuning cells, these may also be logic circuits each comprising at least one transistor.

One example of such a logic circuit is an inverter, but it should be noted that the delay cells/delay tuning cells may be implemented as any one of a large number of different logic circuits, such as an AND-gate, a NAND-gate, an OR-gate, a NOR-gate, etc.

The propagation device may be a transmission line probe arranged to extend towards and into the product contained in the tank for guiding the transmission signal towards the surface of the product, and guiding the reflected signal back along the transmission line probe.

According to another embodiment, the propagation device may comprise an antenna device for radiating the transmission signal towards the surface of the product contained in the tank and capturing the reflected signal resulting from reflection of the transmission signal at the surface of the product contained in the tank.

Furthermore, the level gauge system may advantageously be configured to be powered by a local power source, which may, for example, comprise a battery, a wind turbine, and/or solar cells etc.

Moreover, the level gauge system may further comprise a radio transceiver for wireless communication with an external device.

According to a second aspect of the present invention, the above-mentioned and other objects are achieved through a method of determining a filling level of a product contained in a tank using electromagnetic signals, said method comprising the steps of: generating a transmission signal in the form of a sequence of pulses; propagating said transmission signal towards a surface of said product contained in the tank; receiving a reflected signal resulting from reflection of said transmission signal at said surface of said product; providing a reference signal in the form of a sequence of pulses; forming a measurement signal based on said reference signal and said reflected signal; and determining said filling level based on said measurement signal, wherein at least one of said steps of generating said transmission signal and providing said reference signal comprises the step of: while passing said pulses through a delay path comprising a plurality of delay cells connected in series, varying the number of delay cells connected in series to vary a phase difference between said transmission signal and said reference signal.

Further embodiments of, and effects obtained through this second aspect of the present invention are largely analogous to those described above for the first aspect of the invention.

### BRIEF DESCRIPTION OF THE DRAWINGS

These and other aspects of the present invention will now be described in more detail, with reference to the appended drawings showing example embodiments of the invention, wherein:

FIG. 1 schematically illustrates a level gauge system according to an embodiment of the present invention installed in an exemplary tank;

FIG. 2 is a schematic illustration of the measurement electronics unit comprised in the level gauge system in FIG. 1;

FIG. 3 is a block diagram schematically illustrating the level gauge system in FIG. 1;

FIG. 4a schematically illustrates a first exemplary embodiment of the delay circuitry comprised in the level gauge system of FIG. 3;

FIG. 4b schematically illustrates an exemplary embodiment of the delay tuning circuitry comprised in the delay circuitry of FIG. 3;

FIG. 4c is a diagram illustrating the propagation delay achievable using the delay tuning circuitry in FIG. 4b;

FIG. 4d schematically shows the dependence of the propagation delay on supply voltage for an exemplary delay tuning cell comprised in the delay tuning circuitry in FIG. 4b;

FIG. 5 schematically illustrates a second exemplary embodiment of the delay circuitry comprised in the level gauge system of FIG. 3;

FIG. 6 schematically illustrates a third exemplary embodiment of the delay circuitry comprised in the level gauge system of FIGS. 3; and

FIG. 7 is a flow chart schematically illustrating an embodiment of the method according to the present invention.

### DETAILED DESCRIPTION OF EXAMPLE EMBODIMENTS OF THE INVENTION

In the present detailed description, various embodiments of the level gauge system according to the present invention are mainly discussed with reference to a pulsed radar level gauge system of the non-contact type, in which an electromagnetic signal is propagated towards the product contained in the tank using a propagating device in the form of a radiating antenna, such as a cone antenna, a horn antenna, an array antenna or a patch antenna.

It should be noted that this by no means limits the scope of the present invention, which is equally applicable to pulsed guided wave radar (GWR) level gauge system utilizing a propagating device in the form of a probe, such as a single line probe (including a so-called Goubau probe), a two-lead probe, a coaxial probe, etc.

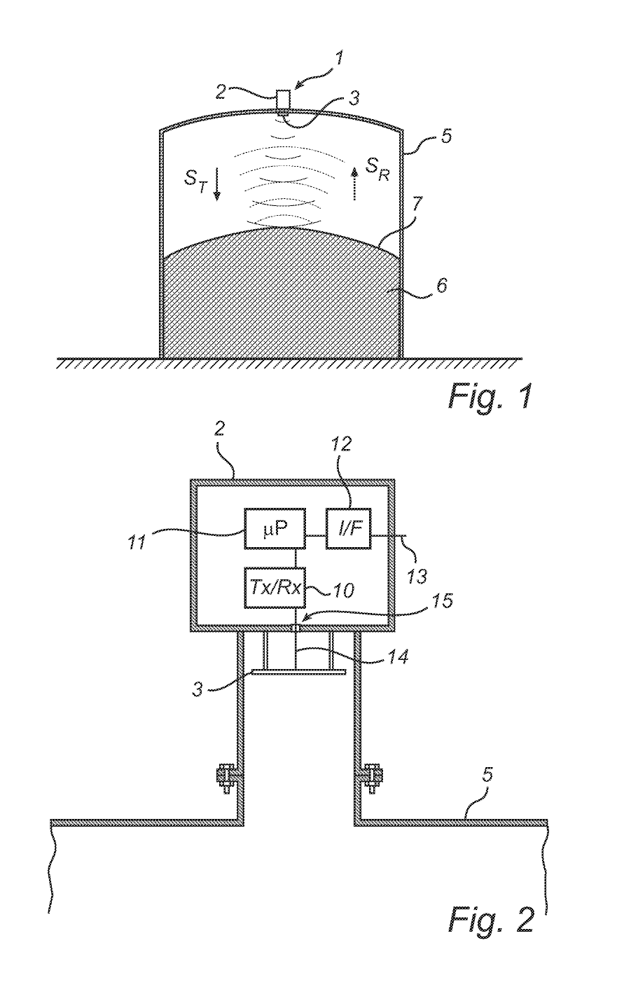

FIG. 1 schematically illustrates a level gauge system 1 according to an embodiment of the present invention, comprising a measurement electronics unit 2, and a propagation device in the form of a radiating antenna device 3. The radar level gauge system 1 is provided on a tank 5, which is partly filled with a product 6 to be gauged. In the case illustrated in FIG. 1, the product 6 is a solid, such as grain or plastic pellets, but the product may equally well be a liquid, such as water or a petroleum-based product. By analyzing a transmission signal S_{T} being radiated by the antenna device 3 towards the surface 7 of the product 6, and a reflected signal S_{R} traveling back from the surface 7, the measurement electronics unit 2 can determine the distance between a reference position and the surface 7 of the product 6, whereby the filling level can be deduced. It should be noted that, although a tank 5 containing a single product 6 is discussed herein, the distance to any material interface present in the tank 5 can be measured in a similar manner.

As is schematically illustrated in FIG. 2, the electronics unit 2 comprises a transceiver 10 for transmitting and receiving electromagnetic signals, a processing unit 11, which is connected to the transceiver 10 for control of the transceiver and processing of signals received by the transceiver to determine the filling level of the product 6 in the tank 5.

The processing unit 11 is, furthermore, connectable to external communication lines 13 for analog and/or digital communication via an interface 12. Moreover, although not shown in FIG. 2, the radar level gauge system 1 is typically connectable to an external power source, or may be powered through the external communication lines 13. Alternatively, the radar level gauge system 1 may be powered locally, and may be configured to communicate wirelessly.

Although being shown as separate blocks in FIG. 2, several of the transceiver 10, the processing circuitry 11 and the interface 12 may be provided on the same circuit board.

In FIG. 2, furthermore, the transceiver 10 is illustrated as being separated from the interior of the tank 5 and connected to the antenna device 3 via a conductor 14 passing through a feed-through 15 provided in the tank wall. It should be understood that this is not necessarily the case, and that at least the transceiver 10 may be provided in the interior of the tank 5. For example, in case the antenna device 3 is provided in the form of a patch antenna as is schematically illustrated in FIG. 2, at least the transceiver 10 and the patch antenna 3 may be provided on the same circuit board.

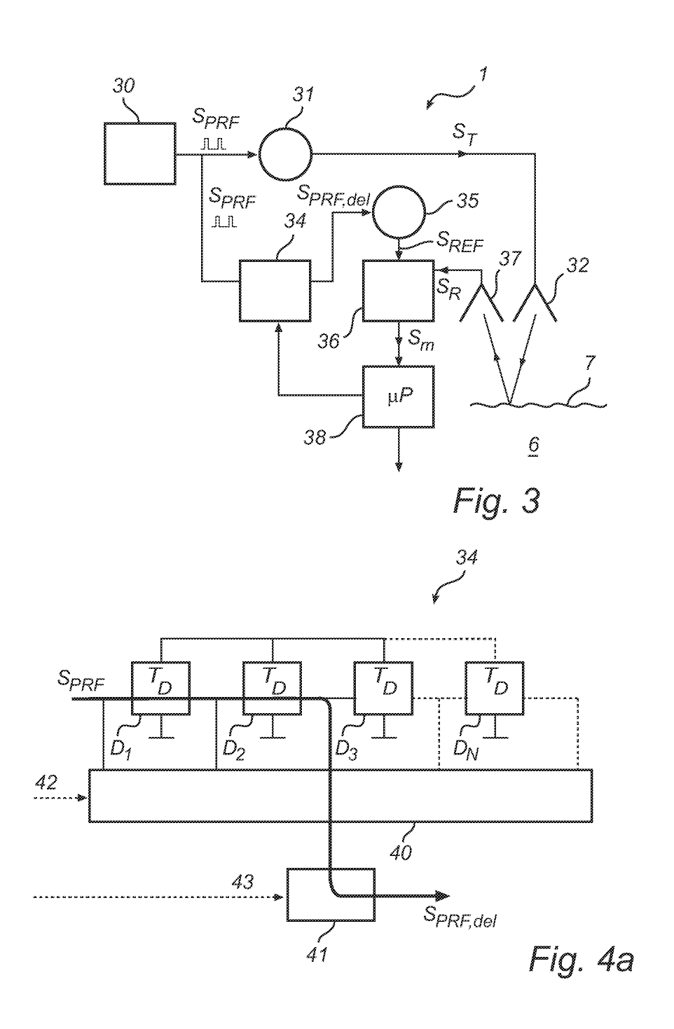

FIG. 3 is a block diagram schematically showing functional components comprised in the level gauge system in FIG. 1. The exemplary level gauge system 1 comprises a transmitter branch and a receiver branch.

The transmitter branch comprises transmission signal generating circuitry, here provided in the form of a pulse generator 30, an RF-source 31 and a transmitting antenna 32, and the receiver branch comprises reference signal providing circuitry in the form of delay circuitry 34, a local oscillator 35, measurement circuitry 36 and a receiving antenna 37.

The microwaves generated by the RF-source 31 are modulated by the pulses S_{PRF} provided by the pulse generator 30 so that a transmission signal S_{T} in the form of a sequence of transmission pulses (short “packets” of microwave energy) is formed and is radiated towards the surface 7 of the product by the transmitting antenna 32.

The reflected signal S_{R} is received by the receiving antenna 37 and is forwarded to the measurement circuitry 36. The measurement circuitry 36 is also provided with a reference signal S_{REF}, which is formed by delaying the pulses S_{PRF} provided by the pulse generator 30 using the delay circuitry 34 and feeding the delayed pulses S_{PRF,del} to the local oscillator 35. The delay circuitry 34 is controlled, which is schematically illustrated by the line from microprocessor 38 to delay circuitry 34, to vary the delay so that the timing difference between the transmission pulses and the reference pulses varies (increases or decreases) over time.

In the measurement circuitry 36, the reference signal S_{REF} and the reflected signal S_{R} are time correlated to form a time-expanded measurement signal Sₘ, which is provided to the microprocessor 38, where the distance to the surface 7 of the product 6 is determined based on the measurement signal Sₘ.

In the exemplary embodiment described above, the reference signal S_{REF} is a delayed version of the transmission signal S_{T}. As will be evident to those skilled in the art, the delay circuitry 34 could equally well be provided on the transmitter branch for delaying the transmission signal so that the transmission signal S_{T} becomes a delayed version of the reference signal S_{REF}. Alternatively, the delay circuitry could be configured to provide delay on both the transmitter branch and the receiver branch. For instance, coarse delay could be provided on the receiver branch and fine delay on the transmitter branch and vice versa.

The measurement circuitry 36 may, for example, comprise a mixer and a sample-and-hold amplifier, but could also be implemented in other ways known to those skilled in the art. For example, the sample-and-hold amplifier may be configured to achieve time-correlation by controlling the sampling switch using the reference signal S_{REF}.

Moreover, for so-called guided wave radar (GWR), the pulses S_{PRF} generated by pulse generator 30 could be propagated directly towards the surface using a transmission line probe. Such a GWR-system may thus function without the RF-source 31 and the local oscillator 35 indicated in FIG. 3.

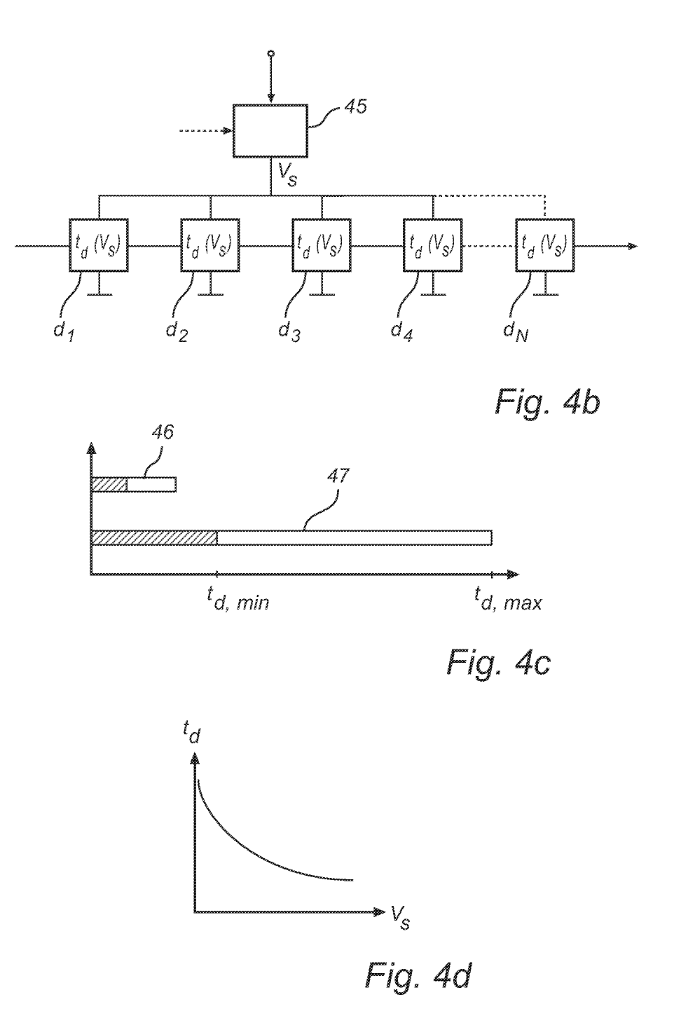

A first exemplary configuration of the delay circuitry 34 of the level gauge system 1 in FIG. 3 will now be described with reference to FIGS. 4a-d.

As is schematically illustrated in FIG. 4a, the delay circuitry 34 comprises a plurality of delay cells D₁-D_{N}, switching circuitry 40 and a delay tuning unit 41. Each delay cell D₁-D_{N} has a propagation delay T_{D}, as is schematically illustrated in FIG. 4a. The switching circuitry 40 is controllable to form a delay path, exemplified by the bold line in FIG. 4a, through a selected number of the delay cells D₁-D_{N}, in this case through D₁ and D₂. Since, in this example, each delay cell D₁-D_{N} has a propagation delay T_{D}, the total propagation delay through D₁ and D₂ is 2T_{D}.

After having passed through the selected delay cells, the signal is routed through the delay tuning unit 41, where a further controllable delay t_{d} may be added to further increase the resolution of the total propagation delay, which in this exemplary case is 2T_{D}+t_{d}. During a timing sweep, the switching circuit 40 may first be controlled, through a switching circuit control signal 42 to pass the signal S_{PRF} to be delayed directly to the delay tuning unit 41, which is controlled by the delay tuning control signal 43 to sweep from t_{d,min} to t_{d,max}. Thereafter, the switching circuit 40 is controlled to pass the signal S_{PRF} to be delayed through the first delay cell D₁, and the delay tuning unit 41 is again controlled to sweep from t_{d,min} to t_{d,max}, etc.

In this particular example, the delay circuitry 34 is implemented in an FPGA, and the delay cells D₁-D_{N} are inverters. The switching circuitry can be implemented in various ways which will be easily realized by those skilled in the art. Of course, the switching circuitry will introduce an additional delay, which, if required, may be compensated for by introducing a corresponding delay in the other branch (in this case in the transmitter branch).

One exemplary way of realizing the delay tuning unit 41 in FIG. 4a will now be described with reference to FIG. 4b.

As can be seen in FIG. 4b, the exemplary delay tuning unit 41 comprises a plurality of delay tuning cells d₁-d_{N} connected in series and voltage control circuitry 45 arranged to allow control of the supply voltage Vₛ provided to the delay tuning cells d₁-d_{N}. Each of the delay tuning cells d₁-d_{N} exhibits a propagation delay for pulses passing therethrough that varies in dependence of the supply voltage provided to the delay tuning cell. By connecting a plurality of delay tuning cells d₁-d_{N} in series, the delay tuning range t_{d,min}-t_{d,max} can be increased as compared to when a single delay tuning cell dₙ is used.

This is schematically illustrated in FIG. 4c, where the top bar 46 illustrates the tunable delay range (dotted) for a single delay tuning cell dₙ, and the bottom bar 47 illustrates the tunable delay range (dotted) for the total delay tuning unit 41 comprising a plurality of delay tuning cells d₁-d_{N} connected in series.

As was mentioned above, each delay tuning cell dₙ exhibits a propagation delay t_{d} that varies in dependence of the supply voltage Vₛ. An example of a delay tuning cell dₙ is a logic circuit, which may be implemented using CMOS technology. Such logic circuits exhibit propagation delays that become shorter with increasing supply voltage Vₛ.

FIG. 4d schematically shows an exemplary dependence of the propagation delay t_{d} on the supply voltage for an example logic circuit in the form of an inverter.

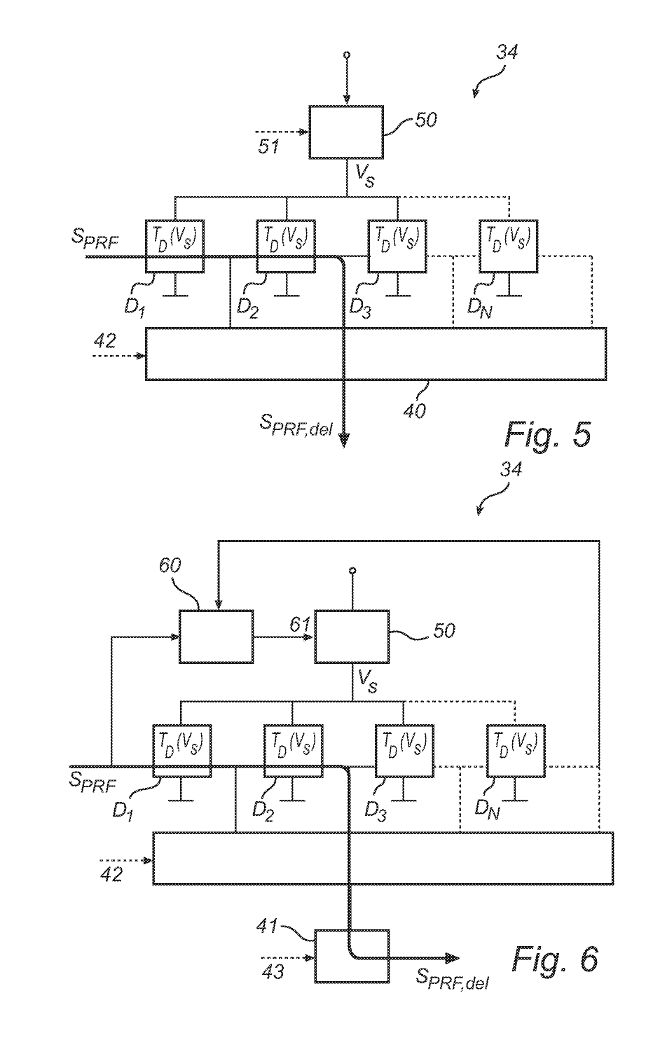

As an alternative to providing a delay tuning unit 41 in series with a delay path formed by a series of delay cells D₁-D_{N}, the delay tuning can be performed by instead tuning the delay cells D₁-D_{N} of the delay circuitry 34 themselves. This will be described below with reference to FIG. 5.

The delay circuitry 34 in FIG. 5 differs from that described above with reference to FIG. 4a in that each of the delay cells D₁-D_{N} exhibits a propagation delay T_{D}(Vₛ) that varies in dependence of the supply voltage Vₛ provided to the delay cells D₁-D_{N}. In analogy with the embodiment of the delay tuning unit 41 described above with reference to FIG. 4b, the delay circuitry 34 in FIG. 5 further comprises voltage control circuitry 50 arranged and configured to provide the delay cells D₁-D_{N} with a supply voltage Vₛ determined by the control signal 51 provided to the voltage control circuitry 50.

With this configuration, the total propagation delay of the delay circuitry 34 can be precisely controlled by determining the number of delay cells to be included in the delay path (D₁ and D₂ in the exemplary case schematically illustrated in FIG. 5) using the switching circuitry 40 and controlling the delay time T_{D}(Vₛ) of these delay cells D₁ and D₂ by controlling the supply voltage Vₛ using the voltage control circuitry 50.

To provide for delay control/regulation and/or calibration of the delay circuitry, a feedback configuration may be used. An example of such a feedback configuration will be described below with reference to FIG. 6.

Similarly to the delay circuitry described above with reference to FIG. 5, the delay circuitry 34 in FIG. 6 comprises supply voltage controlled delay cells D₁-D_{N}, switching circuitry 40 and voltage control circuitry 50. In addition, the delay circuitry 34 in FIG. 6 comprises a phase detector arranged to provide a signal 61 indicative of the propagation delay through all of the delay cells D₁-D_{N}. This signal 61 can in turn be used to control the supply voltage Vₛ provided to the delay cells D₁-D_{N} to keep the propagation delay through all of the delay cells constant. In this manner, the propagation delay T_{D} of each of the delay cells D₁-D_{N} can be kept substantially constant. The total propagation delay of the delay circuitry can be controlled in the same way as was described above with reference to FIG. 4a.

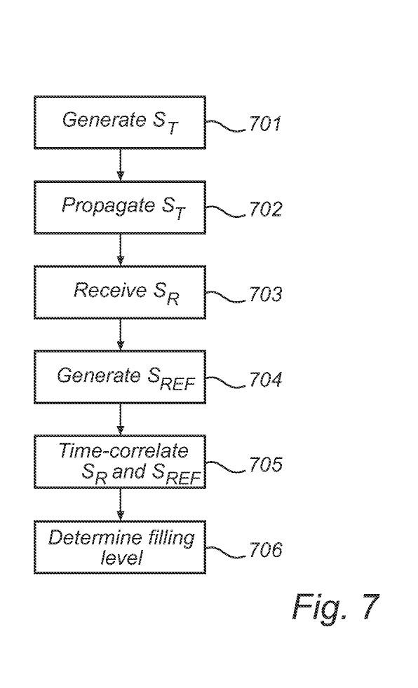

An embodiment of the method according to the present invention will now be described with reference to the flow chart in FIG. 7.

Referring to FIG. 7, a transmission signal in the form of a sequence of transmission pulses is generated in a first step 701, in the next step 702, the transmission signal is propagated towards a surface of the product contained in the tank. The transmission signal is reflected at the surface and is returned as a reflected signal. This reflected signal is received in step 703.

In step 704, pulses from the pulse generating circuitry used to generate the transmission signal are passed through a varying number of delay cells connected in series in order to form a reference signal in the form of a delayed copy of the transmission signal with a time-varying delay.

In the subsequent step 705, a measurement signal is formed by time correlating the reflected signal and the reference signal, and in step 706, the filling level is determined based on the measurement signal formed in step 705.

It is noted that the invention has mainly been described above with reference to a few embodiments. However, as is readily appreciated by a person skilled in the art, other embodiments than the ones disclosed above are equally possible within the scope of the invention, as defined by the appended claims.

It is further noted that, in the claims, the word “comprising” does not exclude other elements or steps, and the indefinite article “a” or “an” does not exclude a plurality. A single apparatus or other unit may fulfill the functions of several items recited in the claims. The mere fact that certain measures are recited in mutually different dependent claims does not indicate that a combination of these measured cannot be used to advantage.

1. A level gauge system, for determination of a filling level of a product contained in a tank using electromagnetic signals, said level gauge system comprising:
transmission signal generating circuitry for generating a transmission signal in the form of a sequence of transmission pulses;
a propagation device connected to said transmission signal generating circuitry and arranged to propagate said transmission signal towards a surface of said product inside the tank, and to return a reflected signal resulting from reflection of said transmission signal at said surface of the product contained in the tank;
reference signal providing circuitry configured to provide a reference signal in the form of a sequence of reference pulses,
at least one of the transmission signal generating circuitry and the reference signal providing circuitry comprising delay circuitry for providing a time-varying phase difference between the transmission signal and the reference signal;
measurement circuitry connected to said propagation device and to said reference signal providing circuitry, said measurement circuitry being configured to provide a measurement signal based on said reference signal and said reflected signal; and
processing circuitry connected to said measurement circuitry for determining a filling level based on said measurement signal,
wherein said delay circuitry comprises:
a plurality of delay cells; and
controllable switching circuitry arranged and configured to allow formation of a delay path comprising a subset of said plurality of delay cells connected in series, to thereby allow control of a signal propagation delay of the delay circuitry.

2. The level gauge system according to claim 1, wherein said delay circuitry further comprises:
at least one delay tuning cell exhibiting a propagation delay for pulses passing through the at least one delay tuning cell that varies in dependence of a supply voltage provided to the at least one delay tuning cell; and
voltage control circuitry connected to the at least one delay tuning cell for providing a controllable supply voltage to the at least one delay tuning cell, to thereby allow control of the propagation delay of the at least one delay tuning cell.

3. The level gauge system according to claim 2, wherein said at least one delay tuning cell is connected in series with said delay path.

4. The level gauge system according to claim 2, wherein said delay circuitry comprises a plurality of delay tuning cells connected in series, each delay tuning cell exhibiting a propagation delay for pulses passing through the delay tuning cell that varies in dependence of a supply voltage provided to the delay tuning cell.

5. The level gauge system according to claim 4, wherein said voltage control circuitry is connected to each of said delay tuning cells to allow simultaneous control of the supply voltage provided to each of said delay tuning cells.

6. The level gauge system according to claim 1, wherein at least one of said delay cells exhibits a propagation delay for pulses passing through the at least one delay cell that varies in dependence of a supply voltage provided to the at least one delay cell, and said delay circuitry further comprises:
voltage control circuitry connected to the at least one delay cell for providing a controllable supply voltage to the at least one delay cell.

7. The level gauge system according to claim 6, wherein each of said delay cells exhibits a propagation delay for pulses passing through the delay tuning cell that varies in dependence of a supply voltage provided to the delay tuning cell.

8. The level gauge system according to claim 7, wherein said voltage control circuitry is connected to each of said delay cells to allow simultaneous control of the supply voltage provided to each of said delay cells.

9. The level gauge system according to claim 6, further comprising a phase detector arranged to provide a signal indicative of a propagation delay through said plurality of delay cells.

10. The level gauge system according to claim 9, wherein said voltage control circuitry comprised in the delay circuitry is connected to said phase detector and configured to provide said controllable supply voltage in dependence of said signal provided by the phase detector.

11. The level gauge system according to claim 1, wherein said switching circuitry comprises controllable switching elements arranged between adjacent ones of said delay cells.

12. The level gauge system according to claim 1, wherein said at least one delay cell is a logic circuit comprising at least one transistor.

13. The level gauge system according to claim 12, wherein said logic circuit is an inverter.

14. The level gauge system according to claim 1, being powered by a local power source comprising at least one device selected from the group comprising a battery device, a solar cell, and a wind turbine.

15. A method of determining a filling level of a product contained in a tank using electromagnetic signals, said method comprising the steps of:
generating a transmission signal in the form of a sequence of pulses;
propagating said transmission signal towards a surface of said product contained in the tank;
receiving a reflected signal resulting from reflection of said transmission signal at said surface of said product;
providing a reference signal in the form of a sequence of pulses;
forming a measurement signal based on said reference signal and said reflected signal; and
determining said filling level based on said measurement signal,
wherein at least one of said steps of generating said transmission signal and providing said reference signal comprises the step of:
while passing said pulses through a delay path comprising a plurality of delay cells connected in series, varying the number of delay cells connected in series to vary a phase difference between said transmission signal and said reference signal.

101-115. (canceled)
